(19) United States
(12) Patent Application Publication
(10) Pub. No.: US 2004/0061333 A1
(43) Pub. Date: Apr. 1, 2004

(54) Conduit coupling

(76) Inventor: Henry C. Chu, Orange, CA (US)

Correspondence Address: CHARLES E. BAXLEY, 5th Floor, 59 John Street, New York, NY, 10038, US

(21) Appl. No.: 10/259,696

(22) Filed: Sep. 30, 2002

(51) Int. Cl. F16L 17/00; F16L 19/06; F16L 19/08; F16L 21/02

(52) U.S. Cl. 285/339

(57) ABSTRACT

A conduit coupling includes a tubular member having a bore formed in one end for receiving one end region of a relatively harder conduit. A ferrule is engaged onto the conduit and has one end region engageable into the end region of the tubular member. A ring has one end region engageable into the other end region of the ferrule and forcible toward the ferrule for both expanding the other end region of the ferrule and moving the ferrule toward the tubular member, to solidly engage the end region of the ferrule onto the outer peripheral surface of the conduit.

### BACKGROUND OF THE INVENTION

1. Field of the Invention

The present invention relates to a conduit coupling, and more particularly to a conduit coupling including a ferrule forcibly and deformably engaged or secured onto the conduit with a ring and a compression fitting.

2. Description of the Prior Art

Various kinds of typical conduit couplings have been provided or developed for securing deformable or soft hoses to relatively harder tubes or conduits with compression fittings.

U.S. Pat. No. 784,372 to Albee, U.S. Pat. No. 1,504,363 to Madigan, U.S. Pat. No. 1,532,886 to Cowles, and U.S. Pat. No. 2,541,200 to Brubaker disclose several of the typical conduit couplings for coupling deformable or soft hoses to relatively harder tubes or conduits.

In these typical conduit couplings, the relatively harder tubes or conduits should include one end having a number of sharp circumferential ribs adapted to engage the inner surface or inner circumferential wall of the deformable or soft hoses. In addition, one or more sealing rings are required to be provided and engaged between the hoses and/or tubes and/or compression fittings. These typical conduit couplings may not be used for solidly securing onto the relatively harder tubes or conduits.

U.S. Pat. No. 2,383,010 to Miller discloses another typical conduit coupling including a performed flared tube to be secured onto a coupling with a split collar and a nut or fastening member.

However, the tube should be machined to form the flared end thereon. In addition, this kind of typical conduit coupling also may not be used for solidly securing onto the relatively harder tubes or conduits.

U.S. Pat. No. 3,468,566 to Nietzel discloses a further typical conduit coupling including an unthreaded conduit to be secured to a threaded conduit with a tapered ferrule. The ferrule may not be deeply engaged into the unthreaded conduit, and thus may not be solidly engaged and secured onto the relatively harder unthreaded conduit.

The present invention has arisen to mitigate and/or obviate the afore-described disadvantages of the conventional conduit couplings.

### SUMMARY OF THE INVENTION

The primary objective of the present invention is to provide a conduit coupling for solidly securing and coupling two relatively harder conduits together in fluid-tight relation without machining or deforming the conduits.

The other objective of the present invention is to provide a conduit coupling including a ferrule forcibly and deformably engaged or secured onto the relatively harder conduit with a ring and a compression fitting.

In accordance with one aspect of the invention, there is provided a conduit coupling comprising a coupling body including a bore formed therein, and including an end region having an outer thread formed thereon, a conduit including an end region received in the bore of the end region of the coupling body, and including an outer peripheral surface, a ferrule engaged onto the outer peripheral surface of the conduit, and including a first end region engageable into the end region of the coupling body, and including a second end region, and forcing means for both expanding the second end region of the ferrule and moving the ferrule toward the coupling body, to engage and force the first end region of the ferrule onto the outer peripheral surface of the conduit.

The coupling body includes an inner tapered surface formed in the end region thereof, the ferrule includes an outer tapered surface formed on the first end region thereof and engaged with the inner tapered surface of the coupling body, for facilitating an engagement of the first end region of the ferrule onto the outer peripheral surface of the conduit. The coupling body may be solidly secured and coupled onto the relatively harder conduit in fluid-tight relation without machining or deforming the end portion of the conduit.

The inner tapered surface of the coupling body includes an inclined angle measured either side of axial centerline thereof, the outer tapered surface of the ferrule includes an inclined angle measured either side of axial centerline thereof and no greater than the inclined angle of the inner tapered surface of the coupling body for facilitating the engagement of the first end region of the ferrule onto the outer peripheral surface of the conduit.

The outer surface of the ferrule extends axially to bring the ferrule to a fine, edgelike, and smaller end region at the first end region thereof.

The forcing means includes a ring engaged onto the conduit and having a first end region engageable into the second end region of the ferrule.

The ferrule includes an inner tapered surface formed in the second end region thereof, the ring includes an outer tapered surface formed on the first end region thereof and engaged with the inner tapered surface of the ferrule.

The inner tapered surface of the ferrule includes an inclined angle measured either side of axial centerline thereof, the outer tapered surface of the ring includes an inclined angle measured either side of axial centerline thereof and no less than the inclined angle of the inner tapered surface of the ferrule for both expanding the second end region of the ferrule and moving the ferrule toward the coupling body.

The ring includes a middle portion having substantially uniform diameter for forming a flat outer surface on the middle portion thereof.

The ring includes a second end region having substantially uniform diameter for forming a flat outer surface on the second end region thereof.

The outer surface of the second end region of the ring includes an outer diameter greater than that of the outer surface of the middle portion of the ring, for defining a peripheral shoulder between the outer surfaces of the second end region and the middle portion of the ring.

The forcing means includes a compression fitting engaged onto the conduit, and having an inner thread for threading with the outer thread of the coupling body, and having a peripheral flange for engaging with the ring, and for forcing the ring and the ferrule toward the end region of the coupling body.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is a perspective view of a conduit coupling in accordance with the present invention;

FIG. 2 is an exploded view of the conduit coupling;

FIG. 3 is a cross sectional view taken along lines 3-3 of FIG. 1;

FIG. 4 is an enlarged partial cross sectional view, illustrating the operation of the conduit coupling;

FIG. 5 is a cross sectional view of a ferrule;

FIG. 6 is a cross sectional view of a ring;

FIG. 7 is a partial perspective view illustrating the conduit coupling after the securing operation onto the conduit and detached from the conduit;

FIGS. 8, 9, 10 are plan schematic views illustrating the other applications or embodiments of the conduit coupling; and

FIG. 11 is a partial cross sectional view illustrating the coupling of a conduit to an elbow with the conduit coupling in accordance with the present invention.

### DETAILED DESCRIPTION OF THE PREFERRED EMBODIMENT

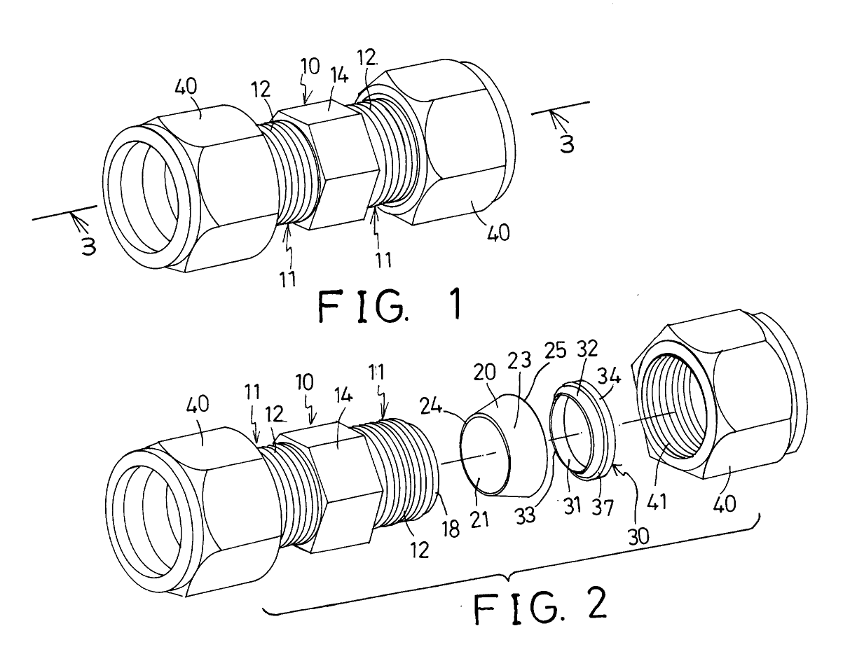

Referring to the drawings, and initially to FIGS. 1-6, a conduit coupling in accordance with the present invention comprises a body or tubular form, or a tubular body 10 including one or both end segments or portions or regions 11 thereof each having an outer thread 12 formed on the outer peripheral portion thereof.

The body 10 preferably includes a peripheral bulge 14 extended radially outward therefrom, such as extended radially and outwardly from the middle portion thereof, for forming the body 10 as a compression fitting, or for allowing the body 10 to be rotated or driven by wrench tools or the like.

The body 10 includes a bore 15 formed therein, such as formed in one or both end regions 11 thereof, for receiving the end regions 71 of relatively harder conduits 70 therein, and thus for securing the relatively harder conduits 70 together, or for solidly securing the body 10 onto a conduit 70 in a fluid-tight relation.

It is to be noted that the end regions 71 of the conduits 70 are smooth or unthreaded both externally and internally, and are not required to be machined or deformed or shaped, and may be solidly secured to the body 10, which will be described hereinafter.

It is preferable that the body 10 includes a peripheral swelling 16 extended radially or inwardly into the bore 15 thereof, for forming or defining one or two inner peripheral shoulders 17 therein, and for receiving or engaging with the end regions 71 of the conduits 70, and thus for solidly retaining the end regions 71 of the conduits 70 in the bore 15 of the body 10.

The body 10 includes one or both end regions 11 each having a tapered surface 18 formed therein and gradually increased in diameter from the bore 15 thereof toward the open end or the end surface 19 thereof. The surface 18 of the body 10 is tapered at a small inclined angle a, about 15°, for example, measured either side of the axial centerline.

A ferrule 20 includes a bore 21 formed therein for receiving the conduit 70, and includes an outer surface 23 which is tapered at a small inclined angle b (FIG. 5), about 13°, for example, measured either side of the axial centerline. The outer surface 23 of the ferrule 20 is adapted to be engaged with the tapered surface 18 of the body 10.

For example, the ferrule 20 has a portion, about one fourth (¼) to one half (½) of its outer surface 23 engaged into or engaged with the tapered surface 18 of the body 10. The outer surface 23 of the ferrule 20 extends far enough axially to bring ferrule 20 down to a rather fine, edgelike, smaller end region 24 at its left hand end (FIG. 5).

The inclined angle b of the ferrule 20 may be equal to, or no greater than, but preferably smaller than the inclined angle a of the body 10, for allowing the smaller end region 24 of the ferrule 20 to be easily forced and moved into the bore 15 of the body 10, due to the sliding engagement between the tapered surface 18 of the body 10 and the tapered outer surface 23 of the ferrule 20.

The ferrule 20 includes an inner peripheral surface 27 formed in the other end region 25 thereof and gradually increased in diameter from the bore 21 thereof toward the open end or the end surface 28 thereof. The tapered surface 27 of the ferrule 20 is tapered at an inclined angle c, about 25°, for example, measured either side of the axial centerline.

The inclined angle c of the ferrule 20 is preferably greater than the inclined angle b of the outer surface 23 thereof, and the inclined angle a of the tapered surface 18 of the body 10.

Another ferrule or a ring 30 includes a bore 31 formed therein for receiving the conduit 70, and includes an outer surface 32 which is tapered at an inclined angle d (FIG. 6), about 27°, for example, measured either side of the axial centerline. The outer surface 32 of the ring 30 is adapted to be engaged with the tapered surface 27 of the ferrule 20.

For example, the ring 30 has a portion, about one half (½) of its outer surface 32 engaged into or engaged with the tapered surface 27 of the ferrule 20. The ring 30 includes a rather fine, edgelike, or sharp or smaller end region 33 at its left hand end (FIG. 6).

The inclined angle d of the ring 30 may be equal to, but preferably no less than or greater than the inclined angle c of the ferrule 20, for allowing the smaller end region 33 of the ring 30 to apply a force against the end region 25 of the ferrule 20, to both expand the end region 25 of the ferrule 20 and to move the ferrule 20 toward the body 10.

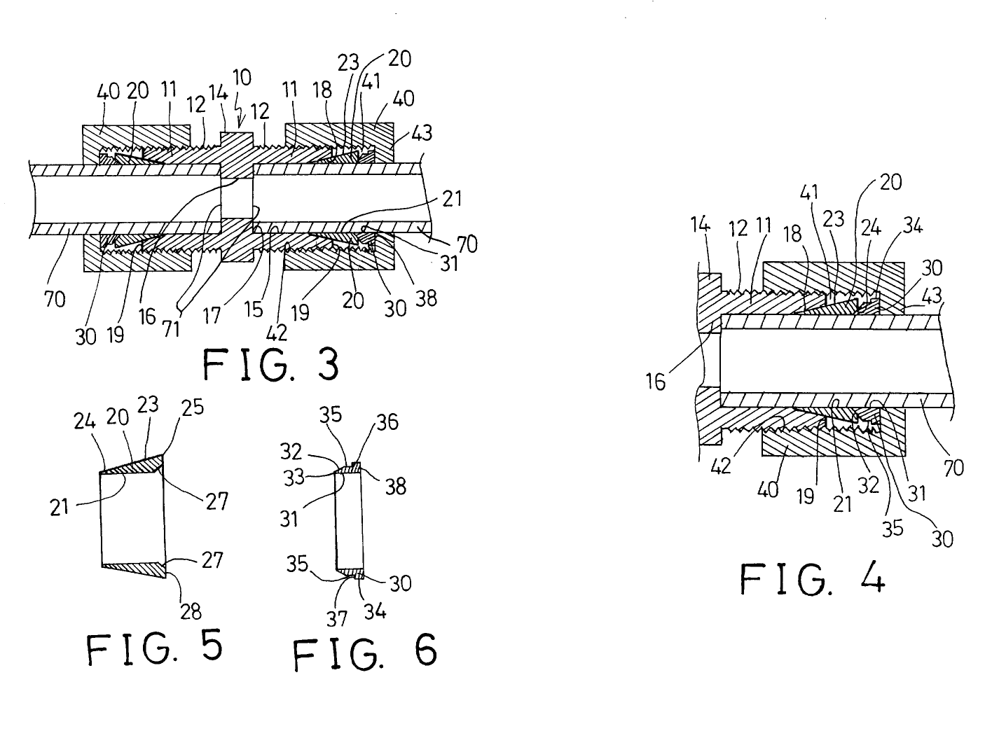

As shown in FIG. 4, when the end region 25 of the ferrule 20 is expanded and moved toward the body 10, the smaller end region 24 of the ferrule 20 may be forced and moved into the bore 15 of the body 10, due to the sliding engagement between the tapered surface 18 of the body 10 and the tapered outer surface 23 of the ferrule 20, and may thus be deformed and solidly engaged into the outer peripheral surface of the conduit 70.

As best shown in FIG. 6, the ring 30 includes two outer peripheral surfaces 34 and 35 formed in the other end region 36 and in the middle portion thereof respectively and having substantially uniform diameter, and having different outer diameter for forming or defining a peripheral shoulder 37 between the outer peripheral surfaces 34, 35 thereof. The ring 30 includes, at its right hand end as shown, an end surface 38.

The flat outer surface 35 of the ring 30 is provided for a somewhat loose fit in the ferrule 20 after the tapered surface 32 has been forced into the ferrule 20. The other flat outer surface 35 of the ring 30 and/or the peripheral shoulder 37 of the ring 30 may be provided for engaging with the end surface 28 of the ferrule 20, and for limiting the movement or engagement of the ring 30 relative to the ferrule 20, and for preventing the ring 30 from over engaging into the ferrule 20.

A compression nut or fitting 40 includes a bore 41 formed therein for receiving either of the end regions 11 of the body 10, and includes an inner thread 42 formed therein for threading with the outer thread 12 of the body 10 and for securing onto the body 10.

The compression fitting 40 includes an inner diameter equals to or slightly greater than the outer diameters of the ferrule 20 and the ring 30, for allowing the ferrule 20 and the ring 30 to be somewhat loosely received in the bore 41 of the compression fitting 40.

The compression fitting 40 includes a peripheral flange 43 extended radially into the bore 41 from one end thereof, such as from the right hand end thereof as shown in FIG. 4, for engaging with the end surface 38 of the ring 30, and for allowing the compression fitting 40 to engage with and to force the ring 30 and thus the ferrule 20 toward the body 10.

As shown in FIG. 4, after the ferrule 20 and the ring 30 are forced toward the body 10 by the compression fitting 40, the smaller end region 24 of the ferrule 20 may be deformed and solidly engaged into the outer peripheral surface of the conduit 70, in annular or circular surface contact or engagement with the conduit 70.

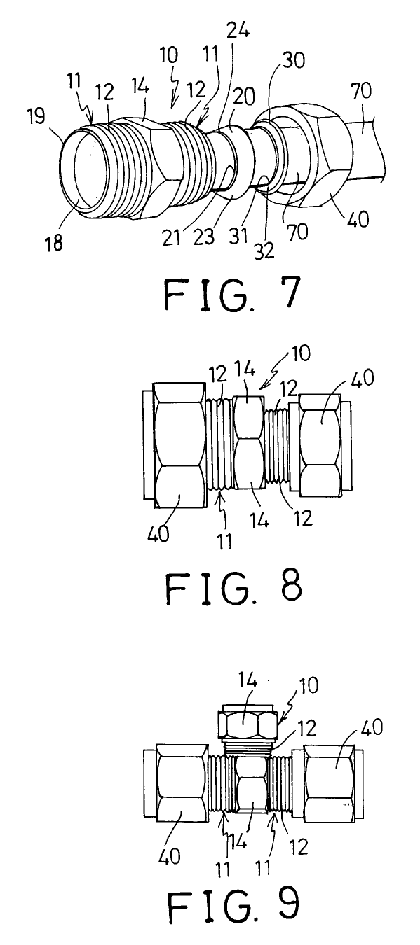

When the compression fitting 40 is then unthreaded or disengaged from the body 10, as shown in FIG. 7, the smaller end region 24 of the ferrule 20 may be deformed and solidly engaged into the outer peripheral surface of the conduit 70 such that the ferrule 20 may not be easily moved or disengaged from the conduit 70. However, the ring 30 and the compression fitting 40 may both be moved relative to the conduit 70.

The material of ferrule 20 and ring 30 should be one which is at least somewhat softer than that of conduits 70 and/or the body 10. Conduit and fitting elements including 70, 10 will often be comprised of materials such as steel, cast and wrought iron, brass, medium hard copper, and rigid plastic.

The ferrule elements including 20 and/or 30 may be any relatively easily deformable material which will yield plastically to conform to sometimes rough and generally harder bounding surfaces. Particularly suitable materials for ferrule elements 20, 30 include Teflon (tetrafluoroethylene polymer), rubber, neoprene (polymerized chloroprene), soft copper, and soft lead.

In any giving case the ferrule material will, it is understood, be chosen to be substantially unaffected chemically by and itself have no reactive effect upon whatever fluid is to flow through conduits 70. It is understood also that conduits 70 need not be fluid-conveying conduits.

In operation, as shown in FIG. 4, the end region 71 of the conduit 70 is engaged into the bore 15 of the body 10, before or after the ferrule 20 and the ring 30 and the compression fitting 40 are engaged onto the conduit 70. The smaller end region 24 of the ferrule 20 may then be engaged into or engaged with the tapered surface 18 of the body 10.

The tapered outer peripheral surface 32 of the ring 30 is then engaged with the tapered inner surface 27 of the ferrule 20, and the compression fitting 40 is then threaded onto the end region 11 of the body 10 and have the peripheral flange 43 thereof engaged with the end surface 38 of the ring 30.

The smaller end region 24 of the ferrule 20 may then be forced to be solidly engaged into the outer peripheral surface of the conduit 70 and to solidly secure the ferrule 20 onto the conduit 70 when the compression fitting 40 is further threaded or rotated onto the end region 11 of the body 10.

After the ring 30 is forced against the ferrule 20, and the ferrule 20 is forced against the body 10, the tapered surface 18 of the body 10 and the tapered outer surface 23 of the ferrule 20 may be caused to be solidly or snugly engaged with each other in fluid-tight relation and surface contact.

It is preferable that the tapered outer peripheral surface 32 of the ring 30 and the tapered inner surface 27 of the ferrule 20 may also be caused to be solidly or snugly engaged with each other in fluid-tight relation and surface contact, for forming a double security fluid-tight relation between the body 10 and the conduit 70.

Referring next to FIG. 8, the body 10 may include two end regions 11 having different outer and/or diameter for receiving or for engaging onto conduits 70 of different outer diameters, and for securing onto the conduits 70 with compression fittings 40 having different diameters.

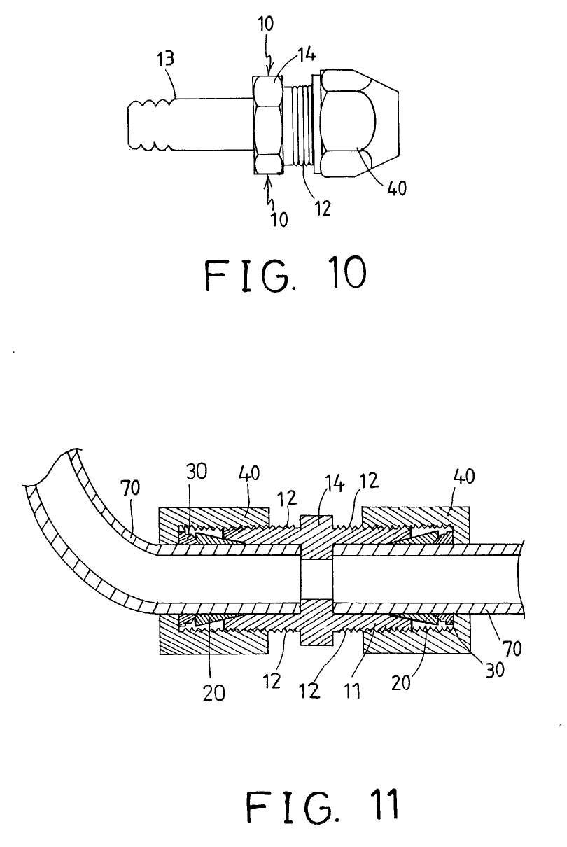

Referring next to FIG. 9, the body 10 may include three end regions 11 having for coupling three conduits 70 together, and may thus be used as a three-way coupling. Referring next to FIG. 10, the body 10 may include a different end region 13 for coupling to the hoses or the like. Referring next to FIG. 11, the conduit coupling may also be easily secured onto the elbow member 80.

It is to be noted that either of the end regions 11 of the body 10 may be engaged onto the end regions 71 of the conduits 70 which are smooth or unthreaded both externally and internally, and may be easily and solidly and quickly secured to the end regions 71 of the conduits 70 with the ferrule 20 and the ring 30 and the compression fitting 40, without machining or deforming or shaping the end regions 71 of the conduits 70.

It is further to be noted that the ring 30 may be formed as a one-integral piece with the compression fitting 40, and may be used as a forcing means or device for both expanding the other end region 25 of the ferrule 20 and for moving the ferrule 20 toward the body 10.

Accordingly, the conduit coupling in accordance with the present invention may be used for solidly securing and coupling two relatively harder conduits together in fluid-tight relation without machining or deforming the conduits, and includes a ferrule that may be deformably secured onto the relatively harder conduit with ring and compression fitting.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A conduit coupling comprising:
a body including a bore formed therein, and including an end region having an outer thread formed thereon,
a conduit including an end region received in said bore of said end region of said body, and including an outer peripheral surface,
a ferrule engaged onto said outer peripheral surface of said conduit, and including a first end region engageable into said end region of said body, and including a second end region, and
forcing means for both expanding said second end region of said ferrule and moving said ferrule toward said body, to engage and force said first end region of said ferrule onto said outer peripheral surface of said conduit.

2. The conduit coupling according to claim 1, wherein said body includes an inner tapered surface formed in said end region thereof, said ferrule includes an outer tapered surface formed on said first end region thereof and engaged with said inner tapered surface of said body, for facilitating an engagement of said first end region of said ferrule onto said outer peripheral surface of said conduit.

3. The conduit coupling according to claim 2, wherein said inner tapered surface of said body includes an inclined angle measured either side of axial centerline thereof, said outer tapered surface of said ferrule includes an inclined angle measured either side of axial centerline thereof and no greater than said inclined angle of said inner tapered surface of said body for facilitating the engagement of said first end region of said ferrule onto said outer peripheral surface of said conduit.

4. The conduit coupling according to claim 2, wherein said outer surface of said ferrule extends axially to bring said ferrule to a fine, edgelike, and smaller end region at said first end region thereof.

5. The conduit coupling according to claim 1, wherein said forcing means includes a ring engaged onto said conduit and having a first end region engageable into said second end region of said ferrule.

6. The conduit coupling according to claim 5, wherein said ferrule includes an inner tapered surface formed in said second end region thereof, said ring includes an outer tapered surface formed on said first end region thereof and engaged with said inner tapered surface of said ferrule.

7. The conduit coupling according to claim 6, wherein said inner tapered surface of said ferrule includes an inclined angle measured either side of axial centerline thereof, said outer tapered surface of said ring includes an inclined angle measured either side of axial centerline thereof and no less than said inclined angle of said inner tapered surface of said ferrule for both expanding said second end region of said ferrule and moving said ferrule toward said body.

8. The conduit coupling according to claim 5, wherein said ring includes a middle portion having substantially uniform diameter for forming a flat outer surface on said middle portion thereof.

9. The conduit coupling according to claim 8, wherein said ring includes a second end region having substantially uniform diameter for forming a flat outer surface on said second end region thereof.

10. The conduit coupling according to claim 9, wherein said outer surface of said second end region of said ring includes an outer diameter greater than that of said outer surface of said middle portion of said ring, for defining a peripheral shoulder between said outer surfaces of said second end region and said middle portion of said ring.

11. The conduit coupling according to claim 5, wherein said forcing means includes a compression fitting engaged onto said conduit, and having an inner thread for threading with said outer thread of said body, and having a peripheral flange for engaging with said ring, and for forcing said ring and said ferrule toward said end region of said body.
